(19) United States
(12) Patent Application Publication
(10) Pub. No.: US 2023/0382020 A1
(43) Pub. Date: Nov. 30, 2023

(54) SYSTEM AND METHOD FOR SECONDARY CONSOLIDATION OF THERMOPLASTIC COMPOSITES

(71) Applicant: Spirit AeroSystems, Inc., Wichita, KS (US)

(72) Inventors: W. Robert Nelson, Wichita, KS (US); Audra Morgan, Wichita, KS (US)

(21) Appl. No.: 18/319,162

(22) Filed: May 17, 2023

Related U.S. Application Data
(60) Provisional application No. 63/345,081, filed on May 24, 2022.

(51) Int. Cl. B29C 35/08; B29C 70/54; B29C 70/42

(52) U.S. Cl. CPC B29C 35/0805; B29C 70/54; B29C 70/42; B29C 2035/0811; B29K 2101/12

(57) ABSTRACT

Embodiments of the present invention relate to a system and method for consolidating a thermoplastic composite component in situ within a thermoplastic composite deposition cell by means of heat and pressure. Heat may be applied to the thermoplastic composite component by means of an induction coil. Pressure may be applied to the thermoplastic composite component by means of a pressure applicator. An independent means may be provided for reacting at least a portion of the force directed to the pressure applicator. Consolidation may be performed in parallel with deposition within the same work cell.

### BACKGROUND

### Field

Embodiments of the present invention relate to a system and method for manufacturing a thermoplastic composite component.

### Related Art

Thermoplastic composite materials have long been of interest to aerostructures manufacturers because they offer several potential advantages when compared to more conventional thermoset composite materials. Unlike thermosets, thermoplastic materials can be re-melted after solidification, thus facilitating recycling of both manufacturing waste and completed aerostructures at the end of their life cycles. This capability can reduce environmental externalities relating to both disposal of waste and manufacture of new material. The same re-meltable characteristic of thermoplastics that facilitates recycling also enables thermoplastic components to be joined into assemblies by welding rather than relying exclusively on fasteners, thereby potentially reducing an assembly's weight as well as simplifying its manufacture. The ability to re-melt a thermoplastic component may also lead to expanded repair options, both during the manufacturing stage and in service. There are significant financial and environmental benefits associated with reducing manufacturing scrap and keeping existing structures in service as long as possible. Perhaps the biggest benefit of thermoplastics from an aerostructure manufacturer's perspective is the potential to “right size” manufacturing processes and eliminate the need for high cost capital equipment such as autoclaves. Autoclaves suitable for thermoplastic processing must operate at high temperatures and are particularly costly, even compared to thermoset-capable autoclaves.

Thermoplastic composite components may, in theory, be manufactured without any separate downstream process analogous to autoclave curing of thermoset composites. It is possible to simply deposit thermoplastic material in a molten state onto a mold surface, layer by layer, with each portion of the material solidifying just after deposition. This technique can be accomplished by means of a specially adapted automated fiber placement (AFP) machine. The process, commonly known as “in situ thermoplastic AFP,” can result in a finished thermoplastic component immediately upon deposition of the final layer of material. In addition to capital savings, in situ thermoplastic AFP completely eliminates the need for vacuum bagging, a labor intensive aspect of conventional composite processing. Along with the labor savings, elimination of vacuum bagging also avoids the ongoing expense and waste associated with bagging materials, which typically must be discarded after every use. Unfortunately, despite its promise, in situ thermoplastic AFP has not been successfully deployed at a large scale in the aerospace industry. In practice, thermoplastic composite components manufactured without further processing steps beyond deposition have been plagued by high levels of porosity and warpage, making them unsuitable for aerospace use.

Warpage and porosity can both potentially be reduced by melting multiple thermoplastic layers during the deposition process rather than taking the typical thermoplastic AFP approach of melting only the layer to be deposited and a portion of the previously deposited layer. By melting more of the underlying material, shrinkage is kept more uniform between layers, and warpage is reduced. Melting more of the underlying material may also reduce porosity by making more molten resin available to flow into voids when pressure is applied. Unfortunately, melting multiple layers with a conventional AFP machine is a slow process because only the surface layer can be heated directly and other layers receive heat only through conduction. Conductivity through the thickness of a carbon fiber reinforced polymer laminate is typically 1-2 orders of magnitude lower than in-plane conductivity, and typically no more than 1 Wm⁻¹ K⁻¹. Thus, a conventional AFP machine must move extremely slowly if it is to heat multiple layers of material. Literature surrounding the use of in situ thermoplastic AFP shows void content below 2 percent can be achieved only at rates of less than approximately 13 meters per minute, which is a fraction of the rate that is possible with thermoset AFP processes. In order to build large aerostructures cost effectively with thermoplastic materials, higher material deposition rates must be achieved with thermoplastic AFP.

The heating limitation described above has been partially addressed by the use of induction heating as part of an AFP process to directly heat underlying layers of material during deposition as proposed in U.S. patent application Ser. No. 16/414,737 (“Calder”). However, the speed achievable by the Calder device is still limited because even when underlying layers of material are heated rapidly via induction, conduction remains the only mechanism by which heat can dissipate from such underlying layers. Pressure must be maintained during the deposition process at each location until the underlying material layers have cooled and solidified, thus limiting process speed. Furthermore, although induction heating can heat each of the layers directly, it cannot heat them uniformly. Induction heating relies on magnetic fields, the strength of which decrease with the square of distance. Therefore, surface layers nearer an induction heating coil are more affected by the magnetic field produced thereby, and thus get hotter than layers further away. To avoid overheating layers near the surface, the overall amount of power that can be applied to a laminate as a whole by induction is limited.

The ability of the Calder approach to address warpage and porosity is also limited by its integration of volumetric consolidation capability into an AFP machine. Any composite deposition process must be driven primarily by the desired orientation of the composite reinforcement fibers to be formed into a finished component. Thus, the path taken by an AFP machine when depositing material is not discretionary and therefore cannot be optimized to reduce warpage or porosity in the resulting laminate. Additionally, Calder's integration of consolidation functionality into an AFP machine constrains the design of the consolidation features themselves, which likewise cannot be fully optimized to address warpage and porosity because they must be compatible with the other nearby AFP machine components. For example, vibration of a consolidation roller attached to an AFP machine, though potentially beneficial from a resin flow standpoint, may interfere with the normal operation of other AFP machine components.

### SUMMARY

The present invention solves the above-described problems and provides a distinct advance in the art of thermoplastic composite manufacture. One aspect of the present invention relates to a process for depositing layers of thermoplastic composite material onto a mold surface and locally consolidating portions of the resulting laminate. Local consolidation may be performed simultaneously with, but independently of, the deposition of material. The sequence of locations at which consolidation is performed may be selected to enhance laminate quality and/or maximize the area consolidated in a given time without interfering with the deposition of material. The present invention's approach of decoupling consolidation functionality from deposition functionality may enable optimization of each. For example, the consolidation process may be performed at a different rate than the deposition process. The consolidation process may entail heating of more layers of material than are heated during the deposition process. The consolidation process may be performed along a path that differs from the deposition path. The deposition and consolidation of thermoplastic composite material according to the present invention may advantageously result in a thermoplastic component having a low porosity level and/or a reduced tendency to warp.

Another aspect of the present invention relates to a device suitable for consolidating a thermoplastic composite laminate independently of the equipment used to deposit material for its manufacture (i.e., a consolidation device not integrated into an AFP machine). The device may include a heating means and a pressure application means. The pressure application means may physically contact the laminate and transmit consolidation force into the laminate. The device may include an oscillatory driver to convey mechanical energy into the laminate via the pressure application means so as to enhance resin flow.

The device may include an independent means of reacting at least a portion of the consolidation force applied by the pressure application means. The independent means of reacting consolidation force may enable the application of a larger consolidation force than would otherwise be possible. The additional force may be applied over an area typical of an AFP machine's consolidation roller, thus generating a greater pressure than would be generated by a typical AFP machine. The higher pressure as compared to an AFP machine's consolidation functionality may result in enhanced consolidation. Alternatively, a consolidation pressure typical of an AFP machine's consolidation pressure may be applied to the laminate by the device, but the additional force enabled by the present invention may enable such typical pressure to be applied over a larger area than would otherwise be possible. The larger area over which force is applied may enable higher process speeds. The pressure application means may be a roller and the apparatus may function by moving over the laminate in a continuous motion while applying pressure. Alternatively, the pressure application means may be a static pressure pad and the apparatus may function by moving incrementally from location to location, applying pressure with the pressure pad only at discrete locations.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the preferred embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of a system for manufacturing a thermoplastic composite component in accordance with an embodiment of the present invention.

FIG. 2 is a perspective view of a material consolidation device according to an embodiment of the present invention.

FIG. 3 is a schematic depiction of aspects of a material consolidation device according to an embodiment of the present invention.

FIG. 4 is a schematic depiction of aspects of a material consolidation device according to a different embodiment of the present invention.

FIG. 5 is a perspective view of a system for manufacturing a thermoplastic composite component in accordance with an embodiment of the present invention.

FIG. 6 is a flow chart depicting steps in a method of manufacturing a thermoplastic composite component in accordance with an embodiment of the present invention.

FIG. 7A is a diagram depicting an exemplary path for material deposition according to an embodiment of the present invention.

FIG. 7B is a diagram depicting an exemplary path for material consolidation according to an embodiment of the present invention.

FIG. 8 is a diagram depicting an exemplary path for a repair routine according to an embodiment of the present invention.

### DETAILED DESCRIPTION

The following detailed description makes reference to accompanying drawings that illustrate specific embodiments of the present invention. Separate references to “an embodiment” or “one embodiment” do not necessarily refer to the same embodiment, though they may. The specific embodiments illustrated and/or described in detail in this disclosure are included to enable those skilled in the art to practice the invention. Other embodiments and variations will be apparent to those skilled in the art and may be substituted without departing from the scope of the present invention. Therefore, the detailed description that follows should not be construed in a limiting sense.

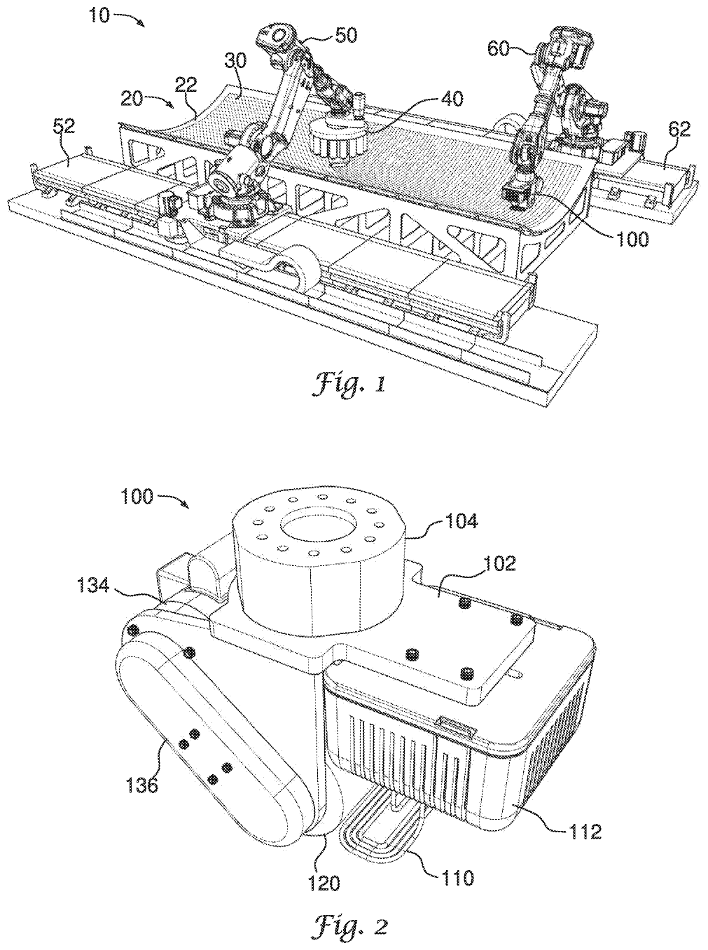

Referring now to the drawings, wherein like reference numerals designate identical or corresponding parts throughout the several views, a system 10 in accordance with an embodiment of the present invention is illustrated in FIG. 1. The system 10 may comprise a mold 20 having a surface 22, a material deposition device 40, and a material consolidation device 100. The system 10 may function to deposit, layer by layer, a plurality of layers of thermoplastic composite material 30 onto a surface 22 of the mold 20, and to consolidate the plurality of layers of thermoplastic composite material 30 by means of the material consolidation device 100, forming a thermoplastic composite component.

The material consolidation device 100 may be configured to apply a consolidation force to at least a portion of the plurality of layers of thermoplastic composite material 30. The material consolidation device 100 may operate in parallel with the material deposition device 40, i.e., the material consolidation device 100 may operate within the same manufacturing cell as the material deposition device 40 and at the same time. Furthermore, multiple material consolidation devices 100 may be operated in conjunction with the material deposition device 40. The material consolidation device 100 may operate at a different rate (i.e., covering a different amount of area in a given time and/or travelling along a different path length in a given time) than the material deposition device.

As an example, the material consolidation device may operate at a rate that enables it to consolidate the entire area of the thermoplastic composite component once for every four layers of material deposited over the entire area of the thermoplastic composite component by the material deposition device 40. The material consolidation device 100 may operate at a rate of less than 13 meters per minute. The material deposition device 40 may be connected to and moved by a first manipulator 50. The material deposition device 40 may deposit material at a rate exceeding 13 meters per minute and may deposit material at a rate of 50 meters per minute or higher. The first manipulator 50 and second manipulator 60 may be programmed so as to prevent interference between the material consolidation device 100 and the material deposition device 40 and/or between the first manipulator 50 and second manipulator 60. The first manipulator 50 may comprise an articulated arm robot and may further comprise a linear rail system 52. The material deposition device 40 is preferably an AFP head, but it may be any device capable of depositing layers of thermoplastic material onto a mold surface such as a tape laying head or a robotic pick-and-place head.

The system 10 may further comprise a nondestructive inspection (NDI) device 150 capable of inspecting the thermoplastic composite component to detect at least one of foreign object debris (FOD) and porosity. The NDI device 150 may be integrated into the material consolidation device 100. The NDI device 150 may comprise a thermal imaging camera configured to gather data for a thermography based evaluation. The heat applied to the plurality of layers of thermoplastic composite material 30 by the material consolidation device 100 (as further described below) may be used as the source of heat required by the NDI device 150. The NDI device may be used to inspect the plurality of layers of thermoplastic composite material 30 immediately after consolidation by the material consolidation device 100, and prior to deposition of all the layers of thermoplastic composite material that will form the finished thermoplastic composite component.

The material consolidation device 100 and the second manipulator 60 may be configured to deviate from their pre-programmed path or sequence to reheat and consolidate areas where porosity is detected. If porosity is detected in an area, the material consolidation device 100 and second manipulator 60 may run a repair routine, locally heating and consolidating the area of the porosity and the area surrounding the porosity before returning to complete their pre-programmed path. While the material consolidation device 100 and second manipulator 60 are running a repair routine, the material deposition device 40 may continue depositing thermoplastic composite material. The system 10 may include a means to coordinate the movements of the first manipulator and second manipulator 60 to avoid interference between the material deposition device 40 and material consolidation device 100. Specifically, the system 10 may include a means to interrupt the operation of the material consolidation device 100 and temporarily reposition the material consolidation device 100 prior to the approach of the material deposition device 40 such that the material deposition device 40 is not interrupted.

The material consolidation device 100 may function to apply heat and mechanical pressure to a localized region of the plurality of layers of thermoplastic composite material 30. The plurality of layers of thermoplastic composite material may have a first surface resting on the surface 22 of the mold 20, and a second surface opposite the first surface upon which the material consolidation device 100 may act to apply mechanical pressure. The material consolidation device 100 may be connected to and moved by a second manipulator 60. The second manipulator 60 may comprise an articulated arm robot and may further comprise a linear rail system 62. The second manipulator 60 may have a maximum rated payload of 1500 kg or less. The second manipulator 60 may have a maximum rated payload of 1000 kg or less. The second manipulator 60 may have a maximum rated payload of 500 kg or less. The material consolidation device 100 and second manipulator 60 may be configured to operate concurrently with the material deposition device 40 and first manipulator 50.

Additional aspects of an embodiment of the material consolidation device 100 are depicted in FIGS. 2, 3 and 4. The material consolidation device 100 may comprise a heating device 110 for locally heating the plurality of layers of thermoplastic composite material 30. The heating device 110 may comprise an induction coil and may further comprise an induction coil driver 112. However, other heating devices are contemplated including microwave heaters, laser heaters, hot air heaters, infrared heaters, flame impingement heaters, and the like. The heating device 110 may be configured to heat multiple layers of the plurality of layers of thermoplastic composite material 30 simultaneously by inducing eddy currents in said layers.

The material consolidation device 100 may further comprise a pressure applicator 120 for applying pressure to the plurality of layers of thermoplastic composite material 30. The pressure applicator 120 may be in the form of a roller, which may advantageously enable the second manipulator 60 to move the material consolidation device 100 over surface 22 of the mold 20 or over the plurality of layers of thermoplastic composite material 30 thereon, while maintaining contact with the pressure applicator 120. The pressure applicator 120, in roller form, may rotate around shaft 132. The shaft 132 may be stationary. Alternatively, the shaft 132 may rotate at a different rate than the pressure applicator 120. The shaft 132 may include an eccentric portion functioning as an oscillatory driver 130 as further described below.

The pressure applicator 120 may be made from such a material, or configured in such a way, that a portion of the pressure applicator 120 reversibly deforms when brought into contact with a surface of the plurality of layers of thermoplastic composite material 30. The portion of the pressure applicator 120 contacting the plurality of layers of thermoplastic composite material 30 in the deformed state may be referred to as a contact patch. The contact patch may have a length 122, a width, and an area.

The pressure applicator 120 may alternatively be in the form of a static pressure pad rather than a roller. In such an embodiment, the material consolidation device 100 may be moved by the second manipulator 60 incrementally between discrete pressure application locations, and such movement may occur only after withdrawing the material consolidation device 100 from contact with the plurality of layers of thermoplastic composite material 30.

The material consolidation device 100 may further comprise an oscillatory driver 130 in mechanical communication with the pressure applicator 120 and configured to transmit oscillatory motion into the plurality of layers of thermoplastic composite material 30 via the pressure applicator 120. The oscillatory driver 130 may comprise an eccentric on a shaft 132 driven by a motor 134 through a belt drive 136. Alternatively, the oscillatory driver 130 may comprise an ultrasonic horn, a pneumatic hammer, or any other device by which oscillatory motion may be imparted.

The material consolidation device 100 may further comprise a cooling device 140 configured to cool a portion of the pressure applicator 120 that is not in contact with the plurality of layers of thermoplastic composite material 30. The cooling device 140 may comprise a nozzle or plurality of nozzles for directing a cooling fluid against the pressure applicator 120. The fluid directed by the cooling device 140 may comprise air, a gas, water, or a liquid. The fluid may change phase when in contact with the pressure applicator 120, thereby enhancing the amount of heat removed from the pressure applicator 120.

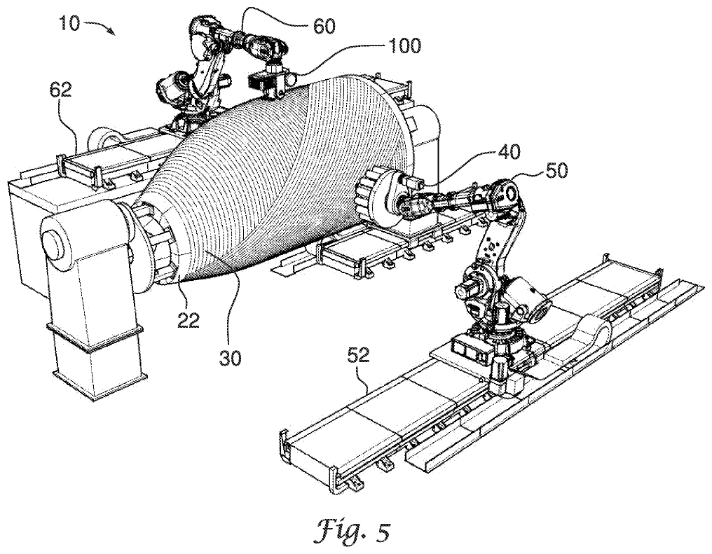

The material consolidation device 100 may further comprise a force reacting element which may comprise at least one of a mass 104 and a magnet 160. The force reacting element may function to react at least some of the force applied by the mold 20 to the pressure applicator 120 via the plurality of layers of thermoplastic composite material 30. The mass 104 may function to enhance the gravitational force acting on the material consolidation device 100. The material consolidation device 100 may be positioned above the mold 20 in operation, such that the gravitational force acting on the material consolidation device 100 contributes to the consolidation force that may be imparted to thermoplastic composite material 30. The mass of the material consolidation device 100 including the mass of the mass 104 may be lower than a rated payload capacity of the manipulator 60, but the force imparted by the pressure applicator 120 to the thermoplastic composite material 30 may be higher than the rated payload capacity of the manipulator 60. The mold 20 may comprise a mandrel having a horizontal rotational axis, and the system 10 may be arranged so that the material consolidation device 100 acts on the top of the mandrel while the material deposition device 40 acts on the side of the mandrel as depicted in FIG. 5. The mandrel may rotate as material is deposited with the material deposition device 40 and as the material consolidation device 100 consolidates the material.

The mold 20 may be composed of a ferromagnetic material and the magnet 160 may be mechanically coupled to the frame 102 of the material consolidation device 100 and magnetically coupled to the mold 20. This arrangement may advantageously react at least a portion of the force imparted to the mold 20 by the pressure applicator 120 locally without relying on a load path extending through either the manipulator 60 or the more distant portions of the mold 20. Thus, the mold 20 may not need to be designed to withstand the very high point loads that would otherwise be imparted by the pressure applicator 120. The magnet 160 may be a permanent magnet, and the position of the magnet 160 with respect to the frame 102 may be adjustable to allow adjustment of the attraction force between the magnet 160 and the mold 20. Alternatively, the magnet 160 may be an electromagnet, and means may be provided to control the power driving the magnet 160, thereby adjusting the attraction force between the magnet 160 and the mold 20. The material consolidation device may comprise both a mass 104 and a magnet 160, thereby maximizing the amount of force that can be applied by the pressure applicator 120.

The ferromagnetic material of the mold 20, when used with a heating device 110 comprising an induction coil, may also serve to provide additional heat to the layers of thermoplastic material 30 that are further away from the induction coil and closer to the mold surface 22. Portions of the mold 20 proximate to the mold surface 22 may be thermally insulated from other portions of the mold 20, so as to reduce the dissipation of heat from away from the mold surface 22 and thermoplastic composite material 30. Providing additional heat to the thermoplastic composite material 30 layers more distant from the heating device 110 may reduce the temperature gradient between the thermoplastic composite material 30 layers, which may result in reduced warpage and improved mechanical performance of the thermoplastic composite component.

The various components of the material consolidation device 100 may be attached to a frame 102. The frame 102 may be connected to the second manipulator 60 via an isolation element (not shown), which may comprise a mass, a damper, or other components known in the art to reduce the transmission of oscillatory forces, such that oscillatory forces created by the oscillatory driver 130 are at least partially isolated from the manipulator 60.

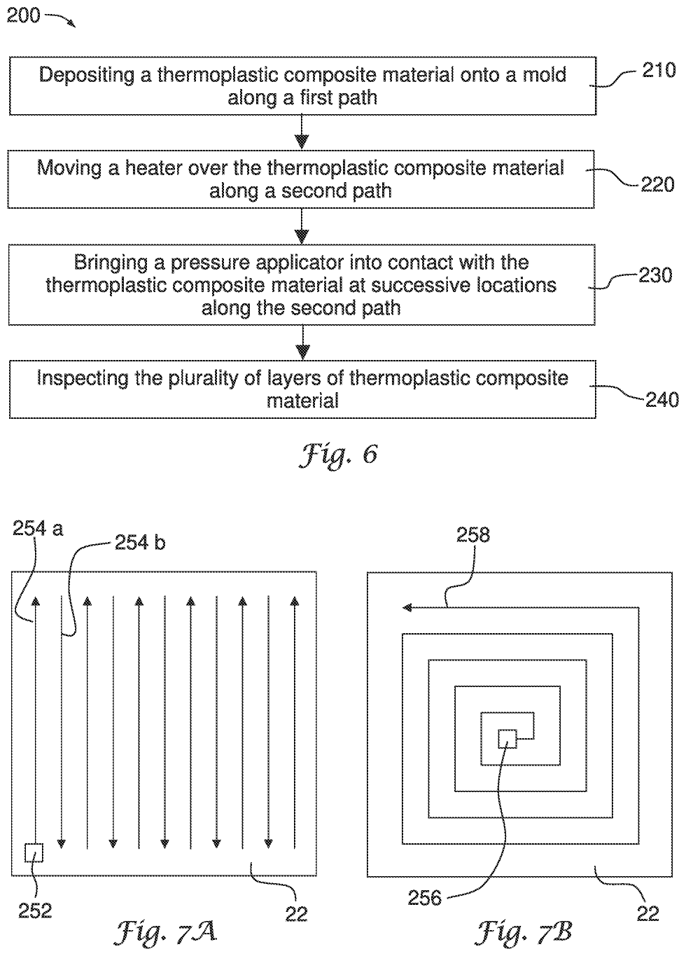

At least a portion of the steps of a method 200 for manufacturing a thermoplastic composite component using the system 10 in accordance with various embodiments of the present invention are listed in FIG. 6. The steps may be performed in the order as shown in FIG. 6, or they may be performed in a different order. Further, some steps may be performed concurrently as opposed to sequentially. In addition, some steps may be omitted. Still further, embodiments of the present invention may be performed using systems other than system 10 without departing from the scope of the invention described herein.

The method 200 may comprise a step of depositing a thermoplastic composite material 30 onto a mold 20 along a first path 254 as depicted in block 210. The material may be deposited manually or by automated means, but the material may preferably be deposited by means of a material deposition device 40 such as an AFP machine. The first path 254 may comprise multiple path segments, e.g., a first segment 254 a and a second segment 254 b.

The method 200 may comprise a step of moving a heater over the thermoplastic composite material 30 along a second path as depicted in block 220, such that a portion of the thermoplastic composite material proximate to the heater melts. The heater may comprise the heating device 110 of the material consolidation device 100. Alternatively, the heater may be selected from alternative devices known in the art to be capable of heating the thermoplastic composite material 30. At least one of the power output of the heater and the rate at which the heater is moved may be selected to ensure that the portion of thermoplastic composite material that melts comprises portions of multiple layers of thermoplastic composite material. Preferably, the portion of thermoplastic composite material that melts comprises portions of at least four (4) layers. More preferably, the portion of thermoplastic composite material that melts comprises portions of at least eight (8) layers. Still more preferably, the portion of thermoplastic composite material that melts comprises at least twelve (12) layers.

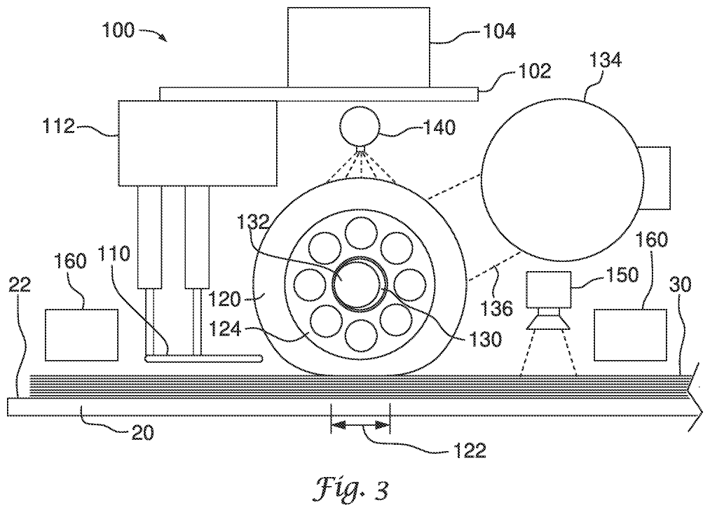

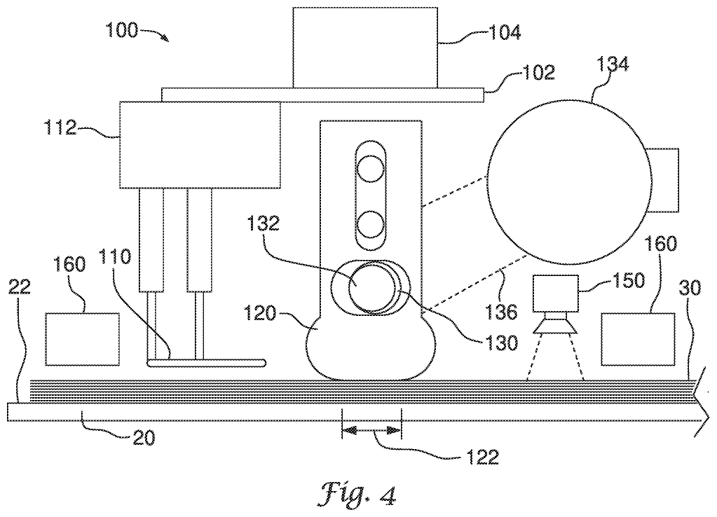

The method 200 may comprise a step of bringing a pressure applicator 120 into contact with the plurality of layers of thermoplastic composite material at successive locations along the second path as depicted in block 230. In the case of a pressure applicator 120 comprising a roller as depicted in FIG. 3, this step may be accomplished by moving the pressure applicator 120 while pressure is maintained. In the case of a pressure applicator 120 comprising a static pressure pad as depicted in FIG. 4, this step may be accomplished by withdrawing the pressure applicator 120 from contact with the plurality of layers of thermoplastic composite material 30, moving it to a new location, and bringing the pressure applicator 120 back into contact with the plurality of layers of thermoplastic composite material 30.

The second path followed in the steps of block 220 and 230 may be different than the first path followed in the step of block 210. For example, the first path may be selected on the basis of the fiber orientation required by the engineering definition of the thermoplastic composite component that is to be formed of the plurality of layers of thermoplastic composite material 30. The first path may preferably be a steered path, that is, a path that deviates from a geodesic path, which may advantageously enable a more precisely controlled fiber alignment in the completed thermoplastic composite component. The second path is not constrained by any fiber orientation definition and may be selected on the basis of manufacturing expediency or to optimize the manufacturing process to improve the quality of the resulting thermoplastic composite component. For example, the second path may be selected to produce a part having reduced porosity or a reduced tendency to warp. FIG. 7A depicts a notional deposition path 254 starting at location 252 and selected to deposit a layer of thermoplastic composite material wherein the thermoplastic composite component design requires all the fibers of the layer to be oriented in a single direction. FIG. 7B depicts a notional consolidation path 258 starting at location 256, which is independent of fiber orientation, and which may be selected to improve part quality. In this case, by starting in the middle of the laminate and working outwards, gas bubbles trapped between layers of thermoplastic composite material may be able to migrate outwards, producing a laminate with lower porosity levels.

Preferably, the consolidation path 258 comprises a natural path. As used herein, a natural path is the path a roller rolling over a surface will naturally take without the introduction of steering forces. A natural path may be a geodesic path, which is the shortest path falling on a contoured surface between two points. Steering of a roller rolling over a surface is difficult or impossible when the force applied by the roller to the surface is high. Therefore, by foregoing any steering and following a natural path, it may be possible to apply a greater amount of force than would otherwise be possible. Thus, following a natural path may enable a larger contact patch to be formed between the pressure applicator 120 and the thermoplastic composite material 30 than would be possible if following a steered path. This may advantageously enable the pressure applicator 120 to be moved at a higher speed over the thermoplastic composite material without any reduction in the time a given point on the surface of the thermoplastic composite material 30 is maintained under pressure.

In addition, by following a different path during compaction than was followed during initial deposition, the pressure applicator 120 of the material consolidation device 100 may more effectively remove porosity and minimize warpage in the thermoplastic composite component. The thermoplastic composite component, having been consolidated by means of material consolidation device 100 following a different path than the material deposition path, may have a porosity content of less than 2 percent over the total area of the thermoplastic component. Width-wise variations in application pressure during deposition of thermoplastic composite material 30 by the material deposition device 40 may be unavoidable due to variations in mold surface 22 contour, ply drops, AFP roller rigidity, and the like. For example, when an AFP machine deposits a strip of material in a longitudinal direction onto a male mandrel having a generally cylindrical form (e.g., the mandrel of FIG. 5), the application pressure imparted by the AFP machine may be lower near the lateral edges of the strip of material and greater near the width-wise centerline of the strip of material. By selecting a consolidation path 258 that differs from the deposition path 254, and is preferably approximately transverse to at least some portions of the deposition path 254, areas subjected to a lower or inadequate pressure during initial deposition are likely to be subjected to a relatively higher pressure during subsequent consolidation.

The mold 20 may preferably be composed of a ferromagnetic material, and the pressure applicator 120 that is brought into contact with the thermoplastic composite material 30 as depicted in block 230 may preferably be mechanically coupled to a magnet 160 that is in turn magnetically coupled to the mold 20. The magnetic attraction between the magnet 160 and the mold 20 may react at least a portion of the force applied by the pressure applicator 120 to the thermoplastic composite material 30. The method 200 may further comprise a step of adjusting the magnetic attraction between the magnet 160 and the mold 20, which may be required to account for changes in the offset between the pressure applicator 120 and the mold surface 22 as additional layers of thermoplastic composite material 30 are deposited. The step of adjusting the magnetic attraction may comprise adjusting the physical position of the magnet 160 if the magnet 160 is a permanent magnet, or may comprise adjusting an electrical power level driving the magnet 160 if the magnet 160 is an electromagnet.

The method 200 may comprise a step of inducing in the thermoplastic composite material 30 an oscillatory pressure by means of the oscillatory driver 130 via the pressure applicator 120. The transient peaks in the force imparted by the pressure applicator 120 to the thermoplastic composite material 30 that exceed the average force imparted by the pressure applicator 120 may be reacted at least in part by at least one of the mass 104 and the magnet 160.

The method 200 may comprise a step of inspecting the plurality of layers of thermoplastic composite material as depicted in block 240. The step of block 240 may be performed using NDI equipment. The NDI equipment may be thermography based and may comprise a thermal imaging camera. The results of the inspection performed by means of the NDI equipment may be used to determine whether additional consolidation is required. Specifically, the NDI equipment may be configured to detect porosity, and the presence of porosity in a particular location may indicate that additional heating and consolidation is required at such location. In the event additional consolidation is required, at least some of the steps of method 200 may be re-performed.

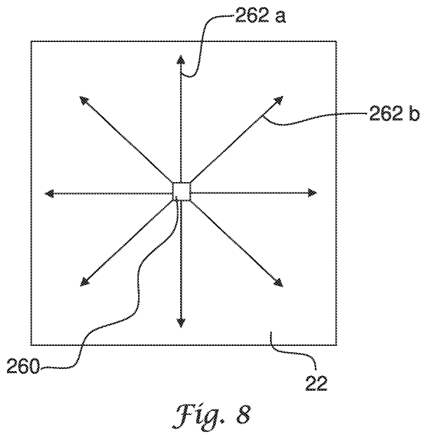

Alternatively, a repair routine may be actuated to correct a defect (e.g., porosity) discovered by the inspection step, wherein the repair routine may comprise moving the heater and pressure applicator along a distinct path optimized for correcting the defect. For example, in the case of porosity, the repair routine may consist of moving the heater and pressure applicator in a “star burst” pattern as depicted in FIG. 8, consisting of multiple path segments 262 a, 262 b, wherein each path segment begins at the location of the porosity 260 and radiates outward in a different direction from other path segments. The material deposition device 40 may continue to operate as a repair routine is performed. In the event the material deposition device 40 would otherwise collide with the heater or pressure applicator 120, the repair routine may be interrupted and the pressure applicator 120 may be moved away from the location of the porosity temporarily so as to avoid interruption of the material deposition device 40. Multiple inspections of the laminate may be performed on the plurality of layers of thermoplastic composite material at various times during the manufacture of the thermoplastic composite component. This may advantageously allow the detection of defects within the plurality of layers of thermoplastic composite material that would not be detectable after all of the layers comprising the thermoplastic composite component have been deposited. For example, thermography techniques may be able to detect porosity near the surface of a laminate, but may be unable to detect porosity located at a greater depth within a thick laminate. Furthermore, additional consolidation may be more effective at eliminating porosity if performed prior to deposition of further layers of composite material.

The present method may comprise the step of dynamically adjusting the consolidation path, the consolidation pressure, the consolidation speed, or another consolidation parameter during the manufacture of a thermoplastic composite component in response to NDI information acquired after the commencement of deposition. The dynamically adjusted consolidation process may proceed in parallel with continued deposition. Deposition may proceed in accordance with the original plan for deposition (e.g., the original N/C program of an AFP machine), with the consolidation activities yielding dynamically as required to avoid interference with the originally planned deposition process.

Although the invention has been described with reference to the preferred embodiments illustrated in the attached drawing figures, it is noted that equivalents may be employed and substitutions made herein without departing from the scope of the invention as recited in the claims.

1. A system for manufacturing a thermoplastic composite component from a plurality of layers of thermoplastic composite material, the system comprising:
a mold;
a material deposition device attached to a first manipulator, wherein the material deposition device is configured to deposit each layer of the plurality of layers of thermoplastic composite material onto a surface of the mold or onto a previously deposited layer of thermoplastic composite material; and
a material consolidation device attached to a second manipulator, wherein the material consolidation device is configured to apply a consolidation force to at least a portion of the plurality of layers of thermoplastic composite material, and wherein the material consolidation device is configured to operate while the material deposition device is operating.

2. The system of claim 1, wherein the material consolidation device further comprises a heating device for locally heating the plurality of layers of thermoplastic composite material.

3. The system of claim 2, wherein the second manipulator comprises an articulated arm robot, and wherein force applied to the plurality of layers exceeds the rated payload capacity of the second manipulator.

4. The system of claim 3, wherein the material consolidation device is positioned above the mold and a gravitational force acting on a mass of the material consolidation device reacts a portion of the force applied to the plurality of layers of thermoplastic composite material.

5. The system of claim 4, wherein the mold comprises a mandrel and wherein the material deposition device is positioned to the side of the mold.

6. The system of claim 2, wherein mold is composed of a ferromagnetic material, wherein the material consolidation device further comprises a magnet, and wherein a magnetic attraction between the magnet and the mold reacts a portion of the force applied to the plurality of layers of thermoplastic composite material.

7. The system of claim 2, wherein the system further comprises an NDI system configured detect porosity present in the plurality of layers of thermoplastic composite material while the plurality of layers of thermoplastic composite material is on the surface of the mold.

8. The system of claim 7, wherein the consolidation device is configured to deviate from the pre-programmed path to perform a repair routine that locally heats and consolidates an area where porosity is present in the plurality of layers of thermoplastic composite material.

9. The system of claim 2, wherein the material consolidation device is configured to operate at a different rate than the material deposition device.

10. The system of claim 9, wherein the material deposition device is configured to deposit material at a rate greater than 13 meters per minute.

11.-22. (canceled)

23. An apparatus configured to be positioned by a manipulator to locally consolidate a thermoplastic composite laminate on a mold, the apparatus comprising:
a heating device configured to locally heat the thermoplastic composite laminate;
a pressure applicator configured to apply a mechanical force over a localized area of the thermoplastic composite laminate, wherein the pressure applicator is configured to reversibly deform in contact with the thermoplastic composite laminate forming a contact patch; and
a force reacting element configured to react at least a portion of the mechanical force applied by the pressure applicator without relying on the manipulator.

24. The apparatus of claim 23, wherein the mold is composed of a ferromagnetic material and the force reacting element comprises a magnet mechanically coupled to the pressure applicator and magnetically coupled to the mold.

25. The apparatus of claim 24, wherein the magnet is an electromagnet.

26. The apparatus of claim 23, wherein the force reacting element is a mass, and wherein the mold is positioned between the apparatus and the ground.

27. The apparatus of claim 23, further comprising an oscillatory driver configured to transmit oscillatory motion into the thermoplastic composite laminate via the pressure applicator.

28. The apparatus of claim 27, wherein the oscillatory driver operates at a frequency of between 2 and 30 Hz.

29. The apparatus of claim 27, wherein the pressure applicator comprises a roller, and wherein the apparatus is configured to be moved in a continuous motion from a first location to a second location while the roller is maintained in contact with a surface of the thermoplastic composite laminate.

30. The apparatus of claim 27, wherein the pressure applicator comprises a pressure pad, and wherein the apparatus is configured to be separated from the thermoplastic laminate while being moved from a first location to a second location.

31. The apparatus of claim 23, wherein the heating device comprises an induction coil configured to induce eddy currents within multiple layers of the thermoplastic composite material.

32. The apparatus of claim 23, further comprising a material deposition device configured to deposit layers of the thermoplastic composite laminate.
